(19) United States
(12) Patent Application Publication
(10) Pub. No.: US 2011/0100651 A1
(43) Pub. Date: May 5, 2011

(54) Ceiling fire extinguishing system with lost air filtration - the ceiling firefighter™

(76) Inventors: James Daniel Dickens, SR., Hazlehurst, GA (US); James Daniel Dickens, JR., Hazlehurst, GA (US)

(21) Appl. No.: 12/925,816

(22) Filed: Oct. 29, 2010

Related U.S. Application Data
(60) Provisional application No. 61/272,800, filed on Nov. 4, 2009.

(51) Int. Cl. A62C 3/00

(52) U.S. Cl. 169/54

(57) ABSTRACT

The Ceiling Firefighter is a Ceiling System (FIG. 2, Assembled View) designed for use within the ceilings of commercial, public and residential buildings that provides a method of mechanical fire extinguishing that offers an alternative or side by side enhancement to help overcome the nine before mentioned limitations of existing sprinkler systems. Comprised of five basic components of structure:
(a) A flame resistant housing or box frame (9) whose face is set an opening or window (11), that conforms to standard ceiling system dimensions (FIG. 2, Assembled View).
(b) A flash burn ridged parchment blister (7) which seals the window side of the box frame housing—secured in place with glue (8), to which its properties are measured to have a low kindling thermal range.
(c) Internal glued (6) structural grid (5) whose main purpose is to reenforce both the ridged parchment flash burn blister (7) and to add overall strength to the unit itself. Secondary purpose is to minimize and limit damage to the unit's ridge parchment flash burn blister (7) to particular cells of the grid (5).
(d) Granulated fire retardant packed within the housing box (4).
(e) Top cover (1) with side flaps (2) on all four sides to be glued (3) to the outer top, outside surface main box housing (9).

### CROSS REFERENCE TO RELATED APPLICATIONS

This application claims the benefit of Provisional Patent Application No. 61/272,800, Filing Date of Nov. 4, 2009.

### FEDERALLY SPONSORED RESEARCH

Not Applicable

### SEQUENCE LISTING OR PROGRAM

Not Applicable

### BACKGROUND

1. Field

As a mechanical device for extinguishing or containing the limitations of fire damage, its application relates to any building's ceiling tile systems that is packed with a flame retardant (4) used to extinguish fires as well as taking advantage of lost air filtration (1) from climate control systems within buildings. See FIGS. 1, 2, and 3.

2. Prior Art

In many commercial, public, and residential buildings, the primary fire extinguishing systems are individual extinguishing canisters and attic mounted sprinkler systems. Canister extinguishing systems require a hand held function thus operating these extinguishes in close proximity of the flames of a fire, putting the operator in danger of exposure to smoke and flames. Most currently used ceiling tile systems at best are flame resistant, designed to only slow the spread of flames. The Ceiling Firefighter™ (FIG. 2, Assembled View) is an optional or stand alone alternative to the ceiling and attic mounted sprinkler systems. Where the Ceiling Firefighter is a ceiling tile system packed with granulated fire retardant (4), contained within the new ceiling tile frame with a flash burn ridged parchment blister (7) for which the flame burns through the parchment releasing the granulated fire retardant onto the flames (FIG. 3, Operational View), thus smothering the fire.

Many sprinkler systems currently in use have nine identified flaws or failures:

(a) They require a continual supply of pressure bearing water. If the supply of water is breached the sprinkler system fails to operate, as witnessed in the World Trade Center on 911.

(b) Sprinkler systems currently have two methods to trigger the water action, either a lead metal trigger that requires enough flame heat to melt the lead trigger, or a smoke sensitive trigger to activate the water based sprinkler action.

(c) The sprinkler action of water dispersed along with compromised electrical systems during a fire can become an electrical hazard to both trapped occupants of a building, and for emergency response personnel.

(d) Mounting brackets for Sprinkler systems can become compromised and fall from the ceiling creating a hazard to occupants and emergency response personnel.

(e) Water supplied sprinkler systems are ineffective against lighter by weight than water, fuel activated flames.

(f) Sprinkler systems that are damaged can cause expensive damage and clean up costs.

(g) Sprinkler systems add weight stress to buildings.

(h) Sprinkler systems are expensive to install and maintain.

(i) Sprinkler systems need routine inspection.

Subsequently, the current ceiling tile systems found in most commercial, public, and residential buildings have their own set of flaws and limitations:

(a) At best, they only slow the spread of fire.

(b) Many still have asbestos media, which has been the subject of expensive legal action for the health hazards such asbestos media produces.

(c) They cause more smoke during a fire.

(d) They do little to save lives.

(e) They do little to save property.

### SUMMARY

Given that the existing fire extinguishing systems such as canister hand held extinguishes require a person to often be in harms way of flames in order to operate them. Sprinkler systems also present additional hazards and limitation to complete function of flame extinguishing. Therefore, a more suitable from of mechanical fire extinguishing shall be found in the side by side or stand alone use of the (FIGS. 2 and 3) Ceiling Firefighter™. To which this system can also provide greater insulation for the use of energy conservation within the control climate of buildings, as well as its air-porous features that can take advantage of a buildings climate control air duct leaks, with passing air through the Ceiling Firefighter's frame (FIG. 1) and granulated packing (4) can also act as an air filtration system, and also deliver aromatic fragrance (4) packed within the frame of the Ceiling Firefighter™.

### DESCRIPTION

### FIELD OF THE INVENTION

This invention relates to ceiling tile system used as a method of mechanical fire extinguishing, energy conservation, and air filtration for improved air quality of buildings, within a restricting of the conventional ceiling systems of buildings. The intended use of the ceiling system is designed as a side by side function with attic sprinkler systems or as a stand alone fire extinguishing system. This invention's purpose is to increase the possible life saving events under building fire situations, and reduce structural damage caused by building fires.

### BACKGROUND

Conventional methods to extinguish fires in buildings have a number of limitations, property damages, dangers, and design inferiorities. None-the-less, the current extinguishing systems in place still hold their value in the event of emergency action. While this invention does not bring an end to the dangers and damages associated with fires, explosions, or terrorist attacks, it does add to the collection of fire fighting tools of fire containment and extinguishing. Included in the advantage of this invention would be its energy conservation properties over current ceiling systems, as well as its ability of take advantage of climate control system within buildings to help filter the air and thus improve air quality for building occupants. This invention needs no continual supply of resources in order to function in its primary purpose to extinguishing and containing fires such as water supply for sprinkler systems. The installation of this ceiling tile is the same as the prior art of conventional ceiling tile systems. The structural systems for holding the ceiling system under other patents would require increased strength to hold this inventions weight. Basically, this invention is intended for the reaction of a fire to extinguish itself.

### SUMMARY OF THE INVENTION

The object of the invention is to overcome at least some of the drawbacks related to current attic installed sprinkler systems such as fuel induced fires, electrical hazards, and supply requirements. As a secondary function to provide improved air quality with its construction materials of a porous nature thus capturing the use of climate control leaks of air handling systems. Finally, the invention provides additional function to conserve energy within the building as well, due to the nature of the granulated fire retardant would also restrict the conduction of thermal transfer, thus improving the performance of air conditioning and central heating systems within buildings.

### BRIEF DESCRIPTION OF THE DRAWINGS

Having described the invention in general terms, reference will be made to the drawings included, which are not necessarily drawn to scale; however, the invention is intended to conform to industry standards for size and dimension of conventional ceiling tile systems, whereby:

FIG. 1 illustrates each of the five major components in an assembly flow diagram.

FIG. 2 demonstrates the final assembly representation of the invention.

FIG. 3 illustrates the operation of the Ceiling Firefighter reacting to flames which cause the flash burn parchment to burn away, thus with gravitational force releasing the granulated fire retardant onto the flames.

### DETAILED DESCRIPTION OF THE INVENTION

The Ceiling Firefighter invention will be described herein with reference to the accompanying drawings, in which evidence of the embodiments of the invention are illustrated. While this invention may be embodied in many different forms and should not be construed as limited to the embodiments set forth in this description; rather, these embodiments are provided by way of examples so that this disclosure will satisfy applicable legal requirements. Thus numbers will refer to like elements throughout.

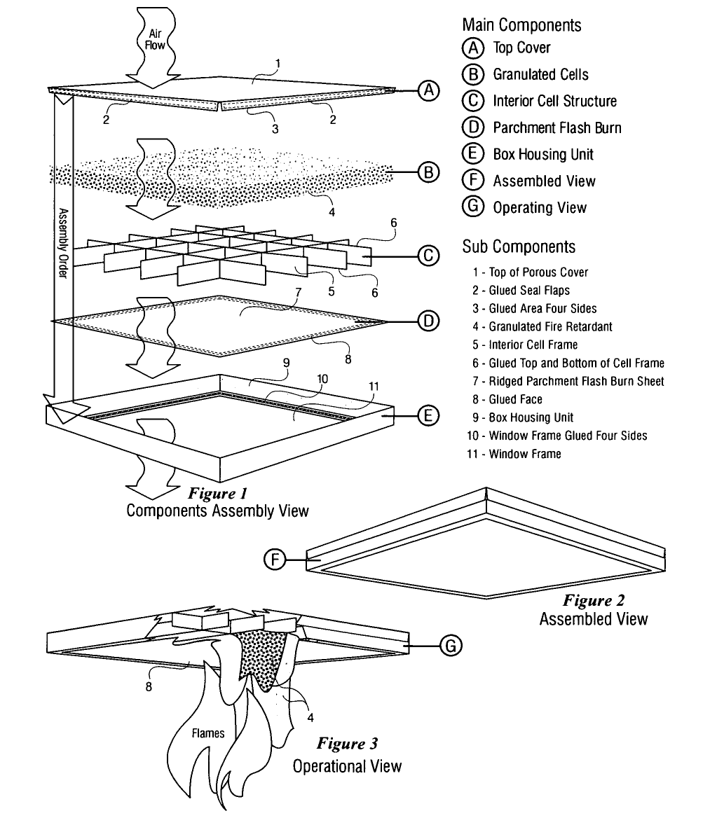

FIG. 1 illustrates in oblique view the five basic components of the invention within the assembly order of each components as they relate to a visual assembly and not necessarily a manufacturing assembly order. The Top Cover (1) consists of four sides with flaps (2) to be glued from the inside (3) of the flaps to the outside top surface of the box housing frame (9). The granulated fire retardant (4) which will be found made of natural substances or synthetic substances not limited to components of sand, detergents, powdered soda, other compounds and mixtures found in other patent applications. The grid cell internal structural system (5) glued top and bottom (6) to conform to the depth of the box housing unit (9) to gain structural stability between the Top Cover (1) and the Ridged Parchment Flash Burn Blister (7). The Ridged Parchment Flash Burn Blister (7) will be glued (8) to the inside face of the box housing window (10), leaving the majority of the Parchment exposed to the outer dimensions of the opening of the window (11). The Ridged Parchment Flash Burn Blister will be constructed of any low kindling material, preexposed to heat, baked or parchment process. Found in standard parchment papers or other synthetic materials produced under separate patents. Finally the Box Housing (9) and Window opening (11) is the final component and it also will have on the inside window frame a glued surface (10) to receive and seal the Ridged Parchment Flash Burn Blister (7) to which its glued surface (8) matches and aligns to the window frame gluing lines (10).

FIG. 2 in a state of usual occupant view, simply illustrates the invention in a state of final assembly, that would conform to standard dimensions of commercial and residential building components and construction standards that are already being used within the market of standards and practices.

FIG. 3 demonstrates the operational action of the invention. When flames of a fire are present they will quickly set fire to and burn away the Ridged Parchment Flash Burn Blister (8) to which at that point gravitational principles take over and the Granulated Fire Retardant (4) is released onto and smothers the flames below the Ceiling Firefighter Ceiling Tile System.

1. A ceiling tile system of a box housing (9) with internal structural grids (5) for providing additional or stand alone fire extinguishing (FIG. 3) to a building's ceiling system in case of building fire, flames burn through the thin ridged parchment (7) thus allowing gravitational release of the granulated fire retardant (4) packed inside the ceiling tile to smother flames (FIGS. 1 and 3).

2. The box housing (9) in claim 1 constructed of flame resistant materials shall have an air-porous nature (FIG. 1) as to allow escaped air of conventional climate control systems to be used to provide filtration and aromatic properties to improve the air quality of a buildings interior.

3. Additionally, as found in claim 1 the internal structural grids (5) glued (6) to form structural strength to the housing (9) and the ridged parchment (7), can be composed of various design shapes (to be found in additional design patents) as to form cells that also limit any damage to the overall systems loss of granulated fire retardant (4).

4. The thin flash burn ridged parchment (7) found in claim 1, is sealed with glue (8) to the inside back of the face of the box housing (9) and is designed of parchment or prekindled material for the purpose of burning away rapidly in order for the gravitational release (FIG. 3) of the granulated fire retardant (4) packed within the box housing (9), also constructed of natural or synthetic materials covered under separate patents.

5. The granulated fire retardant (4) mentioned in claim 1 packed within the housing (9) shall be formed of sand, detergents, powdered soda, or other materials, chemical compounds found in or provided from other patents to which its gravitational properties conforms to a weight standard that will not be over powered by flame and heat up drafts (FIG. 3).

6. The total components of the completed unit in claim 1 when assembled and installed properly in a building also comprise of an energy conservation claim over and above conventional ceiling systems.

7. The box frame housing (9), parchment blister (7), structural cell grid (5), granulated fire retardant (4), are all contained and sealed with glue (3) on the inside edges of the sealing flaps (2) from the top with an air-porous cover top (1). (FIG. 1)
